(19) United States
(12) Patent Application Publication
(10) Pub. No.: US 2023/0219036 A1
(43) Pub. Date: Jul. 13, 2023

(54) TREATMENT OF IMPURITIES IN PROCESS STREAMS

(71) Applicant: 8 Rivers Capital, LLC, Durham, NC (US)

(72) Inventors: Xijia Lu, Durham, NC (US); Brock Alan Forrest, Durham, NC (US); Mohammad Rafati, Durham, NC (US); Damian Beauchamp, Hillsborough, NC (US); David Freed, New York, NY (US)

(21) Appl. No.: 17/948,048

(22) Filed: Sep. 19, 2022

Related U.S. Application Data
(63) Continuation of application No. 15/813,640, filed on Nov. 15, 2017, now abandoned.
(60) Provisional application No. 62/422,316, filed on Nov. 15, 2016.

(51) Int. Cl. B01D 53/78; F23J 15/00; B01D 53/14; F02C 3/04; B01D 53/72; B01D 53/62; F02C 7/18; B01D 53/56; F23J 15/04; B01D 53/60; B01D 53/79; B01D 53/50; B01D 53/76; F02C 3/30

(52) U.S. Cl. CPC B01D 53/78; F23J 15/00; B01D 53/1456; F02C 3/04; B01D 53/72; B01D 53/62; F23J 15/003; F02C 7/185; B01D 53/56; F23J 15/04; B01D 53/60; B01D 53/79; B01D 53/50; B01D 53/76; F02C 3/30; B01D 2257/702; B01D 2257/404; B01D 2258/0283; B01D 2257/60; F23J 2215/40; B01D 2256/22; F05D 2260/213; B01D 2251/104; B01D 2251/108; F23J 2219/40; B01D 2251/106; F23J 2900/15003; F23C 2202/00; F05D 2220/32; B01D 2257/502; F23J 2215/10; F23J 2215/20; B01D 2257/302

(57) ABSTRACT

The present invention relates to a systems and methods for improved removal of one or more species in a process stream, such as combustion product stream formed in a power production process. The systems and methods particularly can include contacting the process stream with an advanced oxidant and with water.

### CROSS-REFERENCE TO RELATED APPLICATIONS

The present application claims priority to U.S. Provisional Patent Application No. 62/422,316, filed Nov. 15, 2016, the disclosure of which is incorporated herein by reference.

### FIELD OF THE INVENTION

The present invention is directed to methods and systems for removal of undesired gases from a process stream, such as a working fluid in a power production cycle.

### BACKGROUND OF THE INVENTION

The combustion of fossil fuels leads predominantly to the formation of CO₂ and H₂O. If the fuel or oxidant supplies used in combustion contain sulfur and/or nitrogen compounds, impurities such as sulfur oxides (“SOx”) and nitrogen oxides (“NOx”) will form alongside the dominant byproducts CO₂ and H₂O. In addition to the potential to form SOx and NOx, non-ideal combustion of fossil fuels will also generate carbon monoxide (CO) as well permit slippage of unburnt hydrocarbons through the combustor without even partial oxidation. Additionally, other flammable gases such as NH₃, H₂S, and COS may be present in the exhaust stream. For example, when such gases are already present in an input fuel stream, at least a portion of such gases may remain in the exhaust as a result of slippage. Likewise, such gases may be present in an exhaust stream when present in an external flow stream that is provided as a bypass around the combustor. In certain cases, fuel gases provided to a combustion system may also contain contaminants such as Hg and other trace metals and fine particulate matter. Given various emission controls requirements, these groups of substances must be removed before a flue gas is released to the environment.

Conventional post-combustion removal of NOx is often performed through Selective Catalytic Reduction (SCR). In this process, the flue gas is passed through a catalyst bed where the NOx comes into contact with NH₄ at elevated temperature (e.g., about 350 to about 450° C.). This interaction leads to the formation of N₂ and H₂O.

SOx removal at power generation facilities is performed through Flue Gas Desulfurization (FGD). An alkaline slurry is placed in contact with flue gas permitting the precipitation of solid particles via the reaction of SOx compounds in the flue gas with alkaline compounds in the slurry. Gypsum (CaSO₄·2H₂O) is the typical product of this interaction. FGD processes often occur at near ambient pressure in a large scrubbing column and at low temperature (e.g., less than about 100° C.).

An alternative means of pre-combustion sulfur removal known as hydrotreating may also be used to control SOx emissions. In this process, gaseous/liquid fuels are passed across a catalyst bed at either ambient temperature or elevated temperature (e.g., about 300° C. to about 400° C.) and elevated pressure (e.g., about 30 bar or greater) in order to strip H₂S in the feedstock. The H₂S must then be converted into either elemental sulfur or sulfuric acid via one of several methods.

In order to control CO emissions, catalytic oxidizers can be employed. Flue gas is passed over a catalyst bed at elevated temperature (e.g., about 260° C. to about 500° C.) where the CO is converted to CO₂ by reducing the catalyst surface. It should be noted that most modern combustion systems used in power systems are designed to minimize CO formation and therefore removal is not frequently employed.

Other conventional means for removal of waste gases (e.g., H₂S and COS) include flaring (or burning) of the flammable portions. This can be a simple process initially, but regulatory standards may add requirements, such as providing scrubbing units (e.g., FGD) to remove various regulated contaminants. If the stream including the flammable gases is not considered a “waste” stream, catalytic oxidation may be required. This, however, is understood to be a source of undesirable work and cost increases because of the requirement for preheating the process fluid laden with the hydrocarbons as well as the added cost of providing catalyst and additional oxygen for injecting into the process stream.

Contaminants such as Hg, trace metals, and particulate matter are typically removed from exhaust gases using a combination of bag filtration and electrostatic precipitation (ESP). These processes result in large energy losses due to the pressure drop created in the bag filtration as a function of the fine particle sizes that are targeted and the electrical energy required to charge the ESP plates for attraction of cation and anion compounds.

In a pressurized semi-closed loop recirculating power cycle, it may not be appropriate to use conventional SCR or FGD technology for NOx and SOx control. Existing equipment is designed for near ambient pressure operation, and is generally designed for much different process gas compositions. Furthermore, elevated exhaust gas pressure increases the likelihood of scaling and plugging when an alkaline slurry is employed for FGD. This means that the scrubbing must happen in an open column (larger sized than one with packing). With respect to SCR, it is desirable to eliminate the need for onsite NH₃ handling. Further, the reduction of NOx to N₂ and H₂O contributes to further contamination of the recirculating working fluid.

Technologies such as the “lead chamber” concept proposed by Air Products are more promising for use in a pressurized direct fired power cycle; however, these too have significant drawbacks. While the NOx and SOx are capable of oxidizing one another to terminal acid species in the presence of excess O₂ and liquid H₂O, the optimal NOx to SOx ratio cannot be absolutely controlled and is largely dependent on the performance of the upstream process. This is due to the fact that these species are fuel derived impurities. Given that a minimal amount of NO₂ is required to achieve near total SO₃ removal, the effective residence time in the scrubbing column must be sufficiently large in order to convert enough NO to NO₂ (as well to permit the NO₂ to dissolve). This leads to conservative column oversizing in order to meet mass transfer needs as opposed to simply thermal transfer requirements. The alternative to increasing residence time is to increase the NO₂ concentration. In a recirculating system, there are ingenious approaches to overcoming this dilemma. This can be facilitated by permitting slippage of NO₂ (or direct addition of NO₂ using an external source) out of the column such that its concentration can build up in the recirculating working fluid. However, this increases the risk of corrosion and can contribute to overall plant emissions if not sized and controlled correctly.

Furthermore, the acidic solution created via the “lead chamber” interactions facilitates the dissolution of Hg and other trace metals into the liquid phase solution. This phenomenon can be problematic given that removal of heavy metals from an acid solution will require special processing.

Enviro Ambient has devised a removal mechanism employing ozone and hydrogen peroxide to oxidize NOx and SOx to acids. While avoiding several issues mentioned above, this particular system cannot readily exploit natural NOx and SOx catalytic interactions that occur rapidly in the presence of excess oxygen and liquid phase water at elevated pressure. Incurred costs are increased by the necessity for multiple stages to independently oxidize each species. The end result is that the total amount of advanced oxidants needed to remove NOx and SOx is much larger than is desirable.

Carbon monoxide is often not considered for removal in power systems given that modern combustion designs specifically target low CO formation. Within a CO₂ rich working fluid, however, the dissociation of CO₂ to CO is feasible, providing another pathway for formation beyond combustion. Moreover, if the oxygen concentration of the combustion process is not properly controlled, and oxygen lean environment can strongly favor the formation of CO along with unburnt hydrocarbons. This must be addressed to prevent emissions and avoid metal carburization. The injection of an oxidation catalyst can be effective to catalyze the oxidation of CO to CO₂, but this typically occurs only in extremely long residence times at near ambient temperature. In light of the foregoing concerns, there remains a need in the art for further systems and methods suitable for removal of various contaminants in a gaseous stream, such as a flue gas.

### SUMMARY OF THE INVENTION

The present invention, in various aspects, relates to systems and methods useful in the purification of a variety of process fluids. In particular, the present disclosure can relate to purification of pressurized combustion products including, but not limited to, gases, such as flue gases. For example, the systems and methods can particularly be useful in removal of gases such as SOx, NOx, hydrocarbons, CO, and other flammable gases. In further embodiments, the systems and methods can be useful in removal of liquids, solids, or semi-solids, such as mercury, trace metals, and particulates. More specifically, the systems and methods can be effective for removal of a wide variety of emissions and thus be beneficial to meet emissions regulations and/or avoid increased rates of corrosion associated with the presence of various materials in the process fluid to be purified. The purification embodiments of the present disclosure can be applied to natural gas combustion cycles, syngas (e.g., from coal) combustion cycles, semi-closed power production cycles utilizing CO₂ as a working fluid, and other pressurized combustion systems. In one or more embodiments, any system that requires treatment of a recirculating (or non-recirculated) working fluid at elevated pressure may be subject to the presently disclosed systems and methods.

In one or more embodiments of the present disclosure, pressurized turbine exhaust enters a recuperative heat exchanger where it is cooled. The pressurized turbine exhaust can contain, for example, any one or more of NOx, SOx, CO, O₂, CO₂, H₂O, unburned hydrocarbons, H₂ and other flammable, non-hydrocarbon gases, as well as Hg, other trace metals, and other particulates. In one configuration, flow may be cooled below the dew point of water, and condensation forms in the exhaust. Prior to the formation of liquid, the exhaust is filtered as a vapor phase through an adsorbent or absorbent such as granular activated carbon (GAC) where a portion of the Hg, trace metals (e.g., vanadium and/or arsenic), and particulates are captured. In embodiments where such liquid phase is formed, the liquid phase can be removed before the stream enters an oxidation reaction unit, which can be a direct contact cooler (e.g., a scrubber, mixer, injector or like component configured for contacting gases with an aqueous material for thermal regulation). The gas phase is cooled gradually to near ambient temperature by a recirculating stream of water which in turn has been cooled by an external cooling apparatus such as a cooling tower. As the gas is cooled, SOx and NOx convert to acids through catalytic interaction and the presence of freely available oxygen and liquid water. The acids precipitate out into the condensing turbine exhaust water and fall to the bottom of the scrubber where they are removed as part of the scrubber's liquid mass balance. The vapor phase gas continues to move upwards with residual SOx and NOx content as well at CO which has negligibly oxidized to CO₂.

Given that the direct contact cooler is simply sized to cool the gas to a design temperature (as opposed for mass transfer), the residence time of the gas in the column is not sufficiently large to permit the complete conversion of all SOx and NOx to liquid phase acids nor the CO to CO₂. A sensor (either upstream or downstream of the direct contact cooler) indicates that the concentration of NOx, SOx, and CO is building in the recycle fluid of the system given slippage at the column. A concentration limit for one or more of the species is met and initiates the injection of an advanced oxidant either upstream and/or into the direct contact cooler. The oxidant may be injected as part of the recirculating water spray or as an independent stream in either the liquid or vapor phase via a mixing device such as a venturi injector. In addition to providing an advanced oxidant, the injection may also be used to add cooled water as a supplement to the scrubber's primary cooling mechanism. The injection of ozone (O₃), peroxide (H₂O₂), and/or another advanced oxidant catalyzes the oxidation of NO to NO₂, SO₂ to SO₃, and CO to CO₂ thereby reducing the total residence time required in the scrubber for total impurities removal through oxidation and dissolution. Other contaminants in the exhaust stream are likewise subjected to oxidation at this point. For example, unburnt hydrocarbons will be oxidized to CO₂ and H₂O, and other flammable gases will be oxidized to form CO₂, SO₂, NO₂, and/or H₂O. In preferred embodiments, the advanced oxidant is injected at, or immediately upstream from, the direct contact cooler so as to substantially prevent acid precipitation when water is present. In various embodiments, however, the advanced oxidant may be injected at one or more points downstream from the turbine exhaust up to and including entry into the direct contact cooler. This can be advantageous to achieve a higher oxidation rate, especially for CO. The advanced oxidant beneficially catalyzes the oxidation of any unburned fuels and other oxidizable compounds present in the exhaust stream.

Optionally, the process stream can be heated by one or more streams in the system. For example, heat from the turbine exhaust stream or from the cleaned, post-oxidation vent stream can be utilized. This can be particularly beneficially for heating a process stream with a high CO concentration to a preferred temperature before passing the stream into an oxidation catalytic bed. The outlet stream of catalytic bed reactor then can be cooled against inlet stream before venting.

The oxidant is continuously added at a sufficient rate to reduce impurity concentrations below their maximum allowable recycle flow limits. The injection of oxidant not only reduces the total residence time need for impurity removal but also accounts for any imbalance in excess O₂ and NO that may hinder total impurity removal given the lack of reactants that may exist.

As a high pressure system, the NOx/SOx catalytic oxidation is used as the primary means of bulk acid gas removal with an advanced oxidant injection serving as a polishing step to remove residual NOx and SOx and any CO. In some embodiments, the oxidation reaction column is sized for the cooling of the recycled flow gas without additional residence time for chemical interactions, with the advanced oxidant flow controlled to provide the necessary removal rate. The intent of this approach is to limit capital expenditures and to incur increased operating expenditures only as needed with the injection of supplemental oxidants.

In one or more embodiments, the present disclosure can provide a system for oxidation of one or more species in a process stream. For example, the system can comprise: a process stream line configured for passage of the process stream including the one or more species; an oxidation reaction unit configured to receive the process stream; a water input line configured for passage of water to the oxidation reaction unit; an advanced oxidant line configured for passage of an advanced oxidant to one or more of the process stream line, the water line, and the oxidation reaction unit; a water output line configured for removal of water from the oxidation reaction unit; and a product line configured for removal of a product from the oxidation reaction unit. In further embodiments, the system can be defined in relation to one or more of the following statements, which can be combined in any order and number.

The one or more species in the process line can include one or more of an acid gas, carbon monoxide, and a hydrocarbon.

The one or more species in the process line can include one or more of NOx, SOx, CO, a hydrocarbon, H₂, COS, and H₂S.

The oxidation reaction unit can be a packed scrubbing column or a water separator.

The oxidation reaction unit can be configured to receive the water and the process stream in an opposing configuration.

The advanced oxidant can comprise a material other than O₂ that is suitable to provide a reactive oxygen species in situ.

The advanced oxidant can comprise a material that is suitable for in situ formation of a hydroxyl radical or a perhydroxyl radical.

The advanced oxidant can comprise a material with a reduction potential that is greater than 0.96 volts vs. Normal Hydrogen Electrode (NHE).

The advanced oxidant can be selected from the group consisting of peroxides, superoxides, ozone, halo-oxides, and combinations thereof.

The advanced oxidant can be a halo-oxide compound having the formula X_{z}O_{y}, wherein: X is Cl, Br, or I, and: if X is Cl, then z is 1 and y is 1, 2, 3, or 4; if X is Br, then z is 1 and y is 1, 2, 3, or 4; and if X is I, then z is 1 and y is 3.

The system can comprise a filter unit upstream from the oxidation reaction unit.

The system can comprise an analyzer in arrangement with the product line and configured to measure a concentration of the one or more species in the product line.

The system can comprise a controller in a working arrangement with the analyzer and configured to control passage of the advanced oxidant through the advanced oxidant line.

In some embodiments, the present disclosure specifically can provide a system for power production. For example, the system can comprise: a combustor configured for receiving a hydrocarbon fuel, an oxidant, and a stream comprising compressed CO₂ and configured for output of a combustion process stream; a turbine configured to expand the combustion process stream to produce power and output a turbine exhaust process stream; a heat exchanger configured to cool the turbine exhaust process stream and output a cooled process stream; and a compressor configured to receive a recycle stream; wherein the system for power production is combined with the system for oxidation of one or more species in a process stream as otherwise described herein such that the oxidation reaction unit is positioned downstream from the heat exchanger and upstream from the compressor.

In one or more embodiments, the present disclosure can provide a method for oxidizing one or more species in a process stream. For example, the method can comprise: providing the process stream comprising the one or more species; passing the process stream comprising the one or more species through an oxidation reaction unit such that the process stream comprising the one or more species mixes with an aqueous stream; contacting the process stream comprising the one or more species with an advanced oxidant one or both of within the oxidation reaction unit and upstream from the oxidation reaction unit; withdrawing water from the oxidation reaction unit; withdrawing a product stream from the oxidation reaction unit; wherein at least a portion of the one or more species is oxidized by the advanced oxidant. In further embodiments, the method can be defined in relation to one or more of the following statements, which can be combined in any order and number

The one or more species in the process stream can include one or more of an acid gas, carbon monoxide, and a hydrocarbon.

The one or more species in the process stream can include one or more of NOx, SOx, CO, a hydrocarbon, H₂, COS, and H₂S.

The oxidation reaction unit can be a packed scrubbing column or a water separator.

The oxidation reaction unit can be configured to receive the water and the process stream in an opposing configuration.

The advanced oxidant can comprise a material other than O₂ that is suitable to provide a reactive oxygen species in situ.

The advanced oxidant can comprise a material that is suitable for in situ formation of a hydroxyl radical or a perhydroxyl radical.

The advanced oxidant can comprise a material with a reduction potential that is greater than 0.96 volts vs. Normal Hydrogen Electrode (NHE).

The advanced oxidant can be selected from the group consisting of peroxides, superoxides, ozone, halo-oxides, and combinations thereof.

The advanced oxidant can be a halo-oxide compound having the formula X_{z}O_{y}, wherein: X is Cl, Br, or I, and: if X is Cl, then z is 1 and y is 1, 2, 3, or 4; if X is Br, then z is 1 and y is 1, 2, 3, or 4; and if X is I, then z is 1 and y is 3.

The method can comprise recycling at least part of the water withdrawn from the oxidation reaction unit to a water source.

The method can comprise analyzing the recycle stream to measure a concentration of the one or more species in the product stream.

The method can comprise adjusting a concentration of the advanced oxidant contacting the process stream based upon the concentration of the one or more species measured in the product stream.

In some embodiments, the present disclosure specifically can provide a method for power production, For example, the method can comprise: combusting a fuel with an oxidant in the presence of compressed CO₂ to form a combustion process stream comprising one or more species; expanding the combustion process stream in a turbine to product power and output a turbine exhaust process stream; cooling the turbine exhaust process stream in a recuperator heat exchanger to provide a cooled process stream; wherein the method for power production is combined with a method for oxidizing one or more species in a process stream as otherwise described herein such that the process stream comprising the one or more species passed through the oxidation reaction unit comprises the cooled process stream provided from the recuperator heat exchanger. Such method can further be defined in relation to one or more of the following statements, which can be combined in any order and number

The method can comprise filtering one or both of the turbine exhaust stream and the cooled process stream from the recuperator heat exchanger to remove one or more of a particulate, mercury, vanadium, and arsenic therefrom.

The method can comprise compressing a stream comprising CO₂ to a pressure suitable for input to the combustor.

The method can comprise passing the compressed stream comprising CO₂ through the recuperator heat exchanger such that the compressed stream comprising CO₂ is heated against the turbine exhaust process stream.

### BRIEF DESCRIPTION OF THE DRAWINGS

FIG. 1 is a flow diagram of a power production system wherein a combustion product stream is treated for removal of one or more species according to an embodiment of the present disclosure;

FIG. 2 is a flow diagram of a system wherein a process stream is treated for removal of one or more species according to an embodiment of the present disclosure; and

FIG. 3 is a flow diagram of a method for power production and for treatment of a process stream for removal of one or more species according to an embodiment of the present disclosure.

### DETAILED DESCRIPTION

Some aspects of the present disclosure will now be described more fully hereinafter with reference to the accompanying drawings, in which some, but not all implementations of the disclosure are shown. Indeed, various implementations of the disclosure may be expressed in many different forms and should not be construed as limited to the implementations set forth herein; rather, these exemplary implementations are provided so that this disclosure will be thorough and complete, and will fully convey the scope of the disclosure to those skilled in the art. As used in the specification, and in the appended claims, the singular forms “a”, “an”, “the”, include plural referents unless the context clearly dictates otherwise.

In one or more embodiments, the present disclosure provides methods and systems for removal of one or more species from a process stream. As used herein, the term “species” is intended to encompass any impurity, contaminant, pollutant, or waste material that may be present in a process stream and be desired for removal therefrom. The species for removal can particularly include acid gases, carbon monoxide, unburned hydrocarbons or other unburned fuels, other flammable materials, metals, and other particulates. Non-limiting examples of species suitable for removal according to one or more embodiments of the present disclosure include NOx, SOx, CO, hydrocarbons (e.g., methane), H₂, COS, H₂S, NH₃, mercury, vanadium, arsenic, and soot.

The present systems and methods are particularly suited for use in removal of one or more species from a process stream in a power generation cycle. More specifically, the power generation cycle can be a cycle with a high pressure recirculating working fluid (e.g., a CO₂ circulating fluid or other circulating fluid). Exemplary power production systems and methods to which the present disclosure may be applied are described in U.S. Pat. No. 8,596,075 to Allam et al., U.S. Pat. No. 8,776,532 to Allam et al., U.S. Pat. No. 8,869,889 to Palmer et al., U.S. Pat. No. 8,959,887 to Allam et al., U.S. Pat. No. 8,986,002 to Palmer et al., U.S. Pat. No. 9,410,481 to Palmer et al., U.S. Pat. No. 9,523,312 to Allam et al., U.S. Pat. No. 9,546,814 to Allam et al., and U.S. Patent Pub. No. 2013/0118145 to Palmer et al., the disclosures of which are incorporated herein by reference. As such, the presently disclosed systems and methods may incorporate any one or more of the components and/or operating conditions described in the referenced documents.

In one or more power production embodiments of the present disclosure, a recirculating working fluid is introduced into a combustor along with fuel and oxidant in order to generate a high pressure, high temperature fluid stream composed of H₂O, CO₂ and one or more further species as otherwise described herein, the fluid stream being configured to drive an expansion turbine and form a turbine exhaust. This mixture of combustion products and circulating working fluid may particularly include acid gases such as NOx, SOx, CO, and unburned fuel (e.g., methane). Although being particularly suited for use in a combustion process, it is understood that the present disclosure relates to treatment of any process stream including one or more impurities, particularly one or more acid gases. As such, the term “process stream” is intended to mean any stream produced in a process such that the stream includes an acid gas (or other species as otherwise described herein) subject to removal via the methods and systems further described herein. Thus, a process stream as used herein may be a combustor exhaust stream or a turbine exhaust stream from a power production process. Although the further disclosure may describe the methods and systems in relation to a combustion process, such description is exemplary, is intended to provide a full description of the invention in relation to an exemplary embodiment, and is not intended to exclude or surrender application of the disclosed methods and systems to process streams arising from other processes.

In one or more embodiments, the process stream for removal of one or more species preferably is pressurized. For example, the process stream can be at a pressure of about 1.5 bar or greater, about 2 bar or greater, about 5 bar or greater, about 10 bar or greater, about 20 bar or greater, or about 50 bar or greater (e.g., up to a pressure that is consistent with modern engineering devices, for example up to 300 bar, 400 bar, or 500 bar). In various embodiments, the process stream can be at a pressure of about 1.5 bar to about 500 bar, about 2 bar to about 400 bar, about 5 bar to about 300 bar, or about 10 bar to about 100 bar. The ability to achieve oxidation for removal of one or more species can be particularly beneficial according to the present disclosure while operating at increased pressure since it is understood that various reactions may proceed with rates that are pressure-dependent. For example, operating at increased pressure can improve the reaction where reaction activity is a function of pressure cubed. Thus, the present disclosure can be particularly beneficial for providing non-linear improvements in reaction chemistry due to the ability to operate at increased pressure.

The process stream prior to removal of the one or more species is preferably substantially cooled to a temperature above ambient either through recuperation or other means. In embodiments related to a power production cycle, after the process stream has undergone cooling, at least a portion of the process stream must be vented in order to maintain mass balance with incoming fuel and oxidant while the remainder will be recycled back into the system. It is therefore desirable to remove combustion derived water and acid gas pollutants, primarily SOx and NOx, as well as carbon monoxide and any unburned hydrocarbons from the working fluid before recycling and/or venting occurs.

In some embodiments, it can be beneficial to cool the process stream before introduction of an advanced oxidant. For example, the process stream into which the advanced oxidant is introduced may be at a temperature of less than about 500° C., less than about 400° C., less than about 300° C., less than about 200° C., or less than about 100° C. (e.g., with a minimum of about ambient temperature). It is possible, however, for oxidation reactions to be carried out at a variety of temperatures. Thus, in various embodiments, the advanced oxidant may be introduced to a stream at any pressure range as follows: about 1000° C. to about 50° C.; about 1000° C. to about 100° C.; about 1000° C. to about 200° C.; about 500° C. to about 30° C.; about 400° C. to about 50° C.; about 300° C. to about 100° C.; about 200° C. to about 30° C.; about 150° C. to about 20° C.; about 150° C. to about 30° C.; about 100° C. to about 20° C.; about 90° C. to about 30° C.; about 70° C. to about 35° C.

In one or more embodiments of the present disclosure, after optionally cooling the process stream, the process stream is passed to an oxidation reaction unit. The oxidation reaction unit can be any device configured for direct contact cooling of the process stream. It thus can be a scrubber, mixer, injector or like component configured for contacting gases with an aqueous material for thermal regulation. In particular, one or multiple streams of cooled water (optionally entrained with an advanced oxidant) are injected into the oxidation reaction unit at one or multiple points. The oxidation reaction unit preferentially can be configured to serve the following functions: 1) cooling the process stream to near ambient temperature; 2) separating water from the process stream; 3) and removing the undesired species (e.g., SOx, NOx, CO, and unburned hydrocarbons) from the process stream.

In some embodiments, the present systems and methods can include one or more filtration units. Preferably, the filtration unit includes an adsorbent such as granulated activated carbon (GAC), and such filtration unit may be placed at one or more relevant points in a system as described herein where the capture of heavy metals (e.g., mercury, vanadium, arsenic, etc.) may be capture in the vapor phase prior to the introduction of an advanced oxidant. The filtration unit can be positioned upstream or downstream of a point where the process stream is cooled to the water dew point; however, the filtration unit is preferably positioned upstream of any point where the advanced oxidant may be injected in order to prevent deactivation of any active filtration components.

It is understood herein that the terms “gas” and “vapor” are interchangeable. Although it is commonly held that the term “gas” implies that all of the material is in the gas phase are room temperature and that the term “vapor” implies a two-phase material comprising a mixture of gas and liquid phases at room temperature, for purposes of the present disclosure, the use of the term “gas” should not be viewed as precluding the presence of any liquid phase material, and the use of the term “vapor” should be viewed as requiring the presence of at least some liquid phase material. Thus, in the use of the terms “gas” and “vapor” it is understood that a portion of the material may or may not be in a liquid phase unless specifically indicated.

Prior to entering the oxidation reaction unit, a portion of any SO₂ and NO (such as derived from combustion) will convert into SO₃ and NO₂ through gas phase NO/O₂/SO₂ reaction mechanisms. As the process stream enters the oxidation reaction unit and continues cooling in the presence of a water wash (without oxidant), SO₃ and NO₂ will dissolve in liquid phase water. This SO₂ and NO will continue to oxidize in the vapor phase as the process stream moves through the oxidation reaction unit. Any vapor phase water will condense out as cooling continues. This will further facilitate the formation and removal of H₂SO₄ and HNO₃ in the liquid phase. Any SOx/NOx/CO and hydrocarbons that have not previously been removed will be removed by the advanced oxidants in the oxidation reaction unit. The present systems and methods are able to utilize the unique system conditions and NOx/SOx/O₂/H₂O reaction mechanism to reduce the consumption of the advanced oxidants, and thus reduce the operating cost of the removal system.

In one or more embodiments, an advanced oxidant can be provided at one or more locations in the process stream and at one or more temperature levels. As noted above, the advanced oxidant can be provided directly into the oxidation reaction unit. Alternatively or additionally, the same or a different advanced oxidant may be provided upstream from the oxidation reaction unit where the process stream may be at a higher temperature. This can enable selective removal of any of NOx, SOx, and CO. As such, it is understood that the use of the term “oxidation reaction unit” should not be viewed as limiting the location of oxidation reaction(s) within the system. While oxidation can preferably occur within the oxidation reaction unit, it is understood that at least a portion of the oxidation reaction(s) may occur upstream from the oxidation reaction unit dependent upon the location of injection of the advanced oxidant(s). Thus, the oxidation reaction unit may, in some embodiments, operate primarily as a separation device for removal of one or more of the oxidation reaction products. In embodiments wherein the process stream is an exhaust stream from a power production cycle, the power system is preferably operated at high pressure with excess oxygen. The process stream exiting the turbine is at the pressure above 10 bar with oxygen concentration above 0.1% molar. The combustion gas exiting the turbine is directed into a heat exchanger where it is substantially cooled to a temperature above ambient before being provided to the oxidation reaction unit. Combustion derived water condensation takes place at the lower end of the heat changer. At this region, as already described above, part of the SO₂ and NO are converted into SO₃ and NO₂ through the gas phase NO/O₂/SO₂ reaction mechanism. Thereafter, SO₃ and NO₂ dissolve in the combustion derived condensed water to form H₂SO₄ and HNO₃ in the heat exchanger. The reaction mechanism can be shown according to the following reactions:

NO+½O₂→NO₂ Reaction 1

2NO₂→N₂O₄ Reaction 2.

2NO₂+H₂O→HNO₂+HNO₃ Reaction 3.

3HNO₂→HNO₃+2NO+H₂O Reaction 4.

NO₂+SO₂→NO+SO₃ Reaction 5.

NO+SO₃→H₂SO₄ Reaction 6.

As described above, the presence of O₂ in a process stream treated according to the present disclosure (either present in excess from a combustion process or added to the process stream) can be beneficial to reduce the amount of advanced oxidants that must be added. It is thus understood that O₂ can be an added oxidant—i.e., an advanced oxidant can be added in addition to O₂, and the ratio of O₂ to advanced oxidant that is added to the combustion product stream can vary. As such, the present disclose can expressly exclude the presence and/or addition of O₂ in a process stream as an advanced oxidant. In some embodiments, O₂ can be present in a process stream in an amount of up to 0.1% molar, 0.2% molar, 0.5% molar, 1% molar, or 2% molar without being considered as being part of the advanced oxidant that is added according to the present disclosure. Preferably, the process stream includes no O₂ or includes O₂ in a concentration of about 0.01% molar to about 2% molar, about 0.05% molar to about 1.5% molar, or about 0.1% molar to about 1% molar.

Although a high pressure system utilizing excess oxygen can be preferred in some embodiments (as discussed above), the present disclosure also encompasses low pressure systems, including systems wherein excess oxygen is not present. A “low pressure” system may, in some embodiments, be defined as a system operating with an exhaust at a pressure of less than 2 bar. It is understood that such low pressure systems can require a greater input of advanced oxidants to achieve optimum removal of NOx, SOx, and/or CO.

A variety of advanced oxidants can be suitable for use according to the present disclosure. In some embodiments, the term “advanced oxidant” can encompass any material commonly recognized as acceptable in advanced oxidation processes. In some embodiments, the term “advanced oxidant” can encompass any material other than O₂ that provides a reactive oxygen species in situ. In some embodiments, the term “advanced oxidant” can encompass any material configured for in situ formation of a hydroxyl radical. In some embodiments, the term “advanced oxidant” can encompass any molecules, compounds, or the combination thereof, in either the form of a gas(es), liquid(s), aqueous salt(s), or dissolved solid(s) (i.e., dissolved solid(s) forming a suspension), or dissolved gas(es), whose reduction potential is greater than 0.96 V (volts) vs. Normal Hydrogen Electrode (NHE). The reduction potential may be directly measured, for example, using a three electrode potentiostat or similar device. In certain embodiments, the term “advanced oxidant” can encompass one or any combination of the materials that are expressly exemplified herein.

As examples, advanced oxidants suitable for use according to the present disclosure can include one or a combination of a peroxide, a superoxide, ozone, or a halo-oxide. A halo-oxide can be a compound having the formula X_{z}O_{y}, wherein: X is Cl, Br, or I; if X is Cl, then z is 1 and y is 1, 2, 3, or 4; if X is Br, then z is 1 and y is 1, 2, 3, or 4; if X is I, then z is 1 and y is 3. Exemplary suitable counter ions for halo-oxides include alkali or alkaline earth metals. As specific examples, reactions 7-9 show the reactions between iodate (IO₃—) and SO₂, NO, and CO, respectively.

2IO₃⁻_{(aq)}+5SO₂⁻²_{(g)}+4H₂O₍ₗ₎→I_{2(l/g)}+5SO₄⁻²_{(aq)}+8H⁺_{(aq)} Reaction 7.

2IO₃⁻_{(aq)}+5NO⁻_{(g)}+4H₂O→I_{2(l/g)}+5NO₃⁻_{(aq)}+8H⁺_{(aq)} Reaction 8.

2IO₃⁻_{(aq)}+6CO_{(g)}I_{2(l/g)}+6CO_{2(g)} Reaction 9.

The advanced oxidant can be added to the process stream at one or more locations in the overall system to achieve the desired level of oxidation. The amount of advanced oxidant that is added to the process stream can vary based the type of species present to be removed, the concentration of the one or more species to be removed, and the reaction kinetics, which can be based upon the pressure of the operating conditions. In one or more embodiments, the total concentration of the advanced oxidant that is added can be in the range of about 0.1 mol % to about 20 mol % based upon the total composition of the process stream (including the advanced oxidant).

In one or more embodiments of the present disclosure, one or more advanced oxidant(s) in the gaseous, liquid, or solid phase can be injected into the oxidation reaction unit. The advanced oxidant can be provided in an aqueous solution and particularly can be injected into a water stream entering the oxidation reaction unit. Preferably, the advanced oxidant enters an upper section of the oxidation reaction unit. One or more gaseous advanced oxidant(s) alternately or additionally can be injected at the bottom of the oxidation reaction unit opposed to the injection of the incoming process stream. The opposing injection configuration can create fluid turbulence to enhance mixing of the process stream and advanced oxidant(s). The flow rate of the advanced oxidants can be adjusted based on the concentration of one or more species for removal present at the exit of the oxidation reaction unit. As such, the system particularly can include one or more gas, liquid, and/or mass detectors. In some embodiments, the detector can include one or more of a gas chromatogram (GC), a mass spectrometer (MS), a GC/MS, a high performance liquid chromatogram (HPLC), or the like. Such detector may be otherwise referenced herein as an analyzer.

The advanced oxidants can be optionally decomposed to generate highly reactive intermediates such as hydroxyl (OH·) and perhydroxyl radicals (·HO₂) before injecting into the oxidation reaction unit. This can be effective to enhance the removal efficiency and further reduce the consumption of the advanced oxidants. It can be done in various ways such as H₂O₂ catalytic oxidation, oxidation in the presence of ozone with catalyst, or a combination of two or more of these methods.

In an exemplified embodiment, a catalyst bed for H₂O₂ decomposition is optionally installed before mixing H₂O₂ with water. Decomposition of H₂O₂ can be catalyzed by substantially pure metals such as iron, silver, copper, manganese and nickel or their oxides such as various iron (III) oxides. Decomposition of H₂O₂ leads to the formation of highly reactive intermediates of hydroxyl and perhydroxyl radicals to enhance SOx/NOx/CO oxidation rate. Other advanced oxidants may be similarly treated for decomposition to form a reactive intermediate. The decomposition of H₂O₂ on the surface of a metal can proceed according to the reactions provided below.

H₂O₂+M⁺→HO·₂+H⁺+M Reaction 10.

H₂O₂+M→M⁺OH·+OH⁻ Reaction 11.

Oxidation of SOx/NOx/CO through OH radical can proceed according to the reactions shown below.

CO+OH·→CO₂+H· Reaction 12.

NO+OH·→HNO₂ Reaction 13.

NO+OH·→NO₂+H· Reaction 14.

SO2+OH·→HSO3 Reaction 15.

In one or more embodiments, the present disclosure can be configured particularly for CO oxidation. For example, a supplemental catalytic bed can be installed upstream of the oxidation reaction unit. The CO₂/process stream along with ozone (excess from water injection that has entered vapor phase) flows through the supplemental catalytic bed and oxidizes the CO to CO₂. As non-limiting examples, the catalyst can be a platinum group metal (PGM), such as palladium or platinum, or an oxide or alloy of cobalt, such as Co₃O₄, or Fe—Co mixed oxide. The addition of the supplemental catalytic bed can be particularly useful to selectively carry out oxidation of CO to CO₂ under the following conditions: 1) significantly lower temperature; 2) lower concentration of the oxidizing agent; and 3) shorter residence time, which translates to smaller reaction volumes.

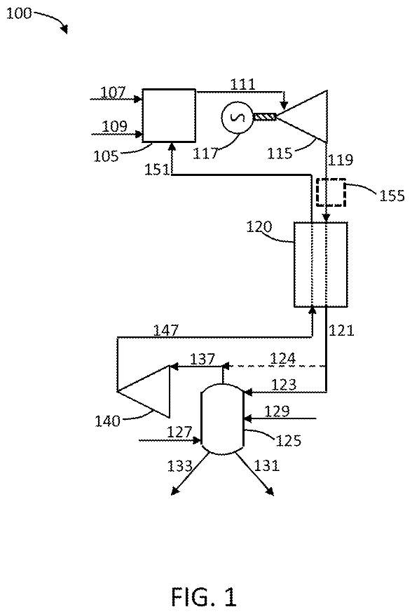

As one example of the implementation of the present disclosure, a power production cycle is illustrated in FIG. 1. As seen therein, a power production cycle 100 includes a combustor 105 where a carbonaceous fuel feed 107 and an oxidant feed 109 are combusted in the presence of a recycle CO₂ stream 151 to form a high pressure, high temperature combustion product stream 111 that is expanded in a turbine 115 to produce power with a generator 117. The exhaust stream 119 (i.e., a process stream as described herein) from the turbine 120 at high temperature is cooled in a recuperative heat exchanger 120 to produce a cooled turbine exhaust stream 121, which typically can contain water, CO₂, and a content of one or more species for removal, such as NOx, SOx, and CO. Optionally, a filter unit 155 can be positioned between the turbine 119 and the heat exchanger 120. Alternatively, the filter unit 155 may be positioned between the combustor 105 and the turbine 115 so as to filter the combustion product stream 111. Alternatively, the filter unit 155 may be incorporated into the line passing through the heat exchanger 120 so that filtration occurs after partial cooling of the stream 119 but before condensation of water vapor in the stream 119 can occur. The entire portion of stream 121 may enter an oxidation reaction unit 125 that includes an input advanced oxidant stream 127 and optionally an input water stream 129. Water may be separated in the oxidation reaction unit 125 and exit as stream 131. Substantially pure CO₂ product stream 133 may be withdrawn for sequestration and/or secondary uses, such as enhanced oil recovery. Recycle stream 137 can comprise substantially pure CO₂, and this recycle stream can be compressed in compressor 140 to form a high pressure recycle CO₂ stream 147. The recycle stream 137 may be considered a product stream in that CO₂ may be a product of the purification system. In some embodiments, cooled turbine exhaust stream 121 may be split so that stream 123 is a first fraction that is input to contact unit 125, and stream 124 is a second fraction that bypasses the contact unit and is combined with recycle stream 137. If desired, an additional quantity of advanced oxidant may be input, for example, into any one or more of stream 119, stream 121, stream 123, and stream 124. The high pressure recycle CO₂ stream 147 is passed to the recuperative heat exchanger 120 where it is heated against the cooling turbine exhaust stream 119 and leaves as stream 151 for input to the combustor 105. The foregoing thus represents one example of how one or more impurities or pollutants can be removed from a process stream, which process stream need not be limited to a combustion product stream per the example of FIG. 1.

In one or more embodiments of the present disclosure, the rate at which the advanced oxidant is provided to the process stream (directly, in an added aqueous stream, or to the oxidation reaction unit) could be varied as a function of downstream chemistry that is analyzed. Because of the added cost of the advanced oxidants, the ability to provide precise controls to the stoichiometrical additions of the advanced oxidants can be highly desired. The present disclosure thus can encompass embodiments wherein the chemistry of one or more output streams is analyzed, and the rate of addition of the advanced oxidant is controlled based upon the concentration of one or more materials in one or more of the output streams.

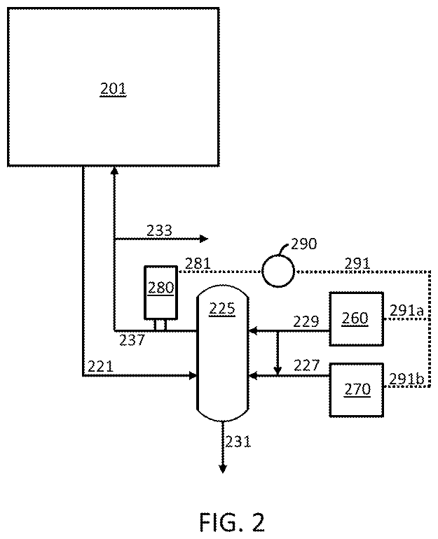

A system and method for control of the input of an advanced oxidant to a process stream is exemplified in FIG. 2. As seen therein, a process stream is output in line 221 from a production system 201. The production system 201 can be a power production cycle, such as power production cycle 100 from FIG. 1; however, the power production system 201 can be any system wherein a process stream is output, and wherein the process stream includes one or more species suitable for undergoing an oxidation reaction as described herein.

The process stream in line 221 is input to an oxidation reaction unit 225 as otherwise described herein. An advanced oxidant from an advanced oxidant source 260 is input to the oxidation reaction unit 225 through line 229. Alternatively or additionally, the advanced oxidant in line 229 can be passed to a water line 227 to be mixed with water from a water source 270 prior to passage into the oxidation reaction unit 225. Although not illustrated, it is understood that the advanced oxidant from the advanced oxidant source 260 (alone or in combination with water from water source 270) may be input directly into line 221 upstream of the oxidation reaction unit 225. This may be carried in the alternative or in addition to the input directly to the oxidation reaction unit 225.

Water exits the oxidation reaction unit 225 through line 231, and a recycle stream exits in line 237. The recycle stream may be considered a product stream. The recycle stream typically can comprise CO₂ as a product of the oxidation reaction and/or as a recycled product from the process stream (e.g., when CO₂ is used as a working fluid in a power production cycle). The recycle stream in line 237 can be a substantially pure stream of CO₂. In other embodiments, the recycle stream in line 237 can include a content of one or more species for removal. The process conditions can be such that a certain content of one or more species for removal may be acceptable or expected. This can indicate that the addition of the advanced oxidant is at a desired level or that advanced oxidant is not needed. The concentration of the one or more species can be measured by an analyzer 280 or other measurement device (e.g., a GC, MS, GC/MS, HPLC, or the like). The analyzer 280 can be in communication with a control unit 290 via a control input 281 whereby a measured value is delivered from the analyzer 280 to the control unit 290. The control unit 290 can carry out one or more predefined algorithms that considers a variety of inputs, including mass flow through the system, oxygen content in one or more lines, reaction stoichiometry in the production system 201, and the content of the one or more species in the line 237. The control unit 290 then can provide at least one control output 291 to one or more of the water source 270, the advanced oxidant source 260, the advanced oxidant line 229, and the water line 227. For example, the control output 291a may activate a pump (not shown) in the advanced oxidant source 260, and/or the control output 291b may activate a pump (not shown) in the water source 270. Additionally or alternatively, the control output 291a may activate a valve (not shown) in the advanced oxidant line 229 and/or the control output may activate a valve (not shown) in the water line 227. The output signal can cause a lesser or greater amount of one or both of advanced oxidant in line 229 and water in line 227 to be delivered to the oxidation reaction unit 225. A specific, acceptable concentration range for one or more impurities, contaminants, or waste materials may be pre-set, and as the concentration of any of the one or more species exceeds the pre-set range, the analyzer 280 that is measuring the concentration of said species can deliver the output signal to the controller, which in turn can signal the appropriate injection of the advanced oxidant into the system. Injection of the advanced oxidant may continue until the analyzer 280 registers a return to the accepted range for the one or more species, at which time the injection of the advanced oxidant may be reduced or completely paused. In this way, the present disclosure provides for cost effective regulate of both capital expenses and operating expenses related to emissions control by simultaneous exploiting the oxidant reactions and high pressure catalytic interactions of the unwanted species.

As can be seen from the foregoing, the present disclosure thus provides for a system for oxidation of one or more species in a process stream. The system can include combinations of the following components in various embodiments: lines for passage of the process stream between one or more further system components; at least one oxidation reaction unit (e.g., a packed scrubbing column, a water separator, or other component configured for direct mixing of the process stream with at least water, which optionally includes the advanced oxidant); one or more lines for passage of advanced oxidant; one or more lines for passage of water; one or more pumps for movement of the advanced oxidant; one or more pumps for movement of the water; one or more mixers for combining advanced oxidant with water; one or more valves for controlling flow of advanced oxidant through an advanced oxidant line; one or more valves for controlling flow of water through the water line; one or more lines for removal of a product (e.g., a recycle stream, such as a CO₂ containing stream) from the oxidation reaction unit; one or more analyzers for measuring or detecting the concentration of a species flowing through a line; one or more controllers configured to receive an input signal and deliver an output signal; and one or more control lines configured for passage of input and/or output signals. In particular embodiments, the system for oxidation of one or more species can include components such that the overall system is a power production system. As such, the system can include, in addition to any combination of the above components, the following components: a combustor configured to combust a hydrocarbon fuel in an oxidant in the presence of a working fluid and output a combustion exhaust process stream; a turbine configured to receive the combustion exhaust process stream, expand the combustion exhaust process stream to produce power, and output a turbine exhaust process stream; a recuperator heat exchanger configured to receive the turbine exhaust process stream and transfer heat from the turbine exhaust process stream to a recycle stream; a compressor and/or a pump configured to receive and compress a recycle stream; and lines for passage of the process streams between the combustor, the turbine, the recuperator heat exchanger, the compressor and/or pump, and any components otherwise described above. It is understood that any of the components described above may include at least one input configured to receive a process stream and/or at least one output configured to deliver a process stream.

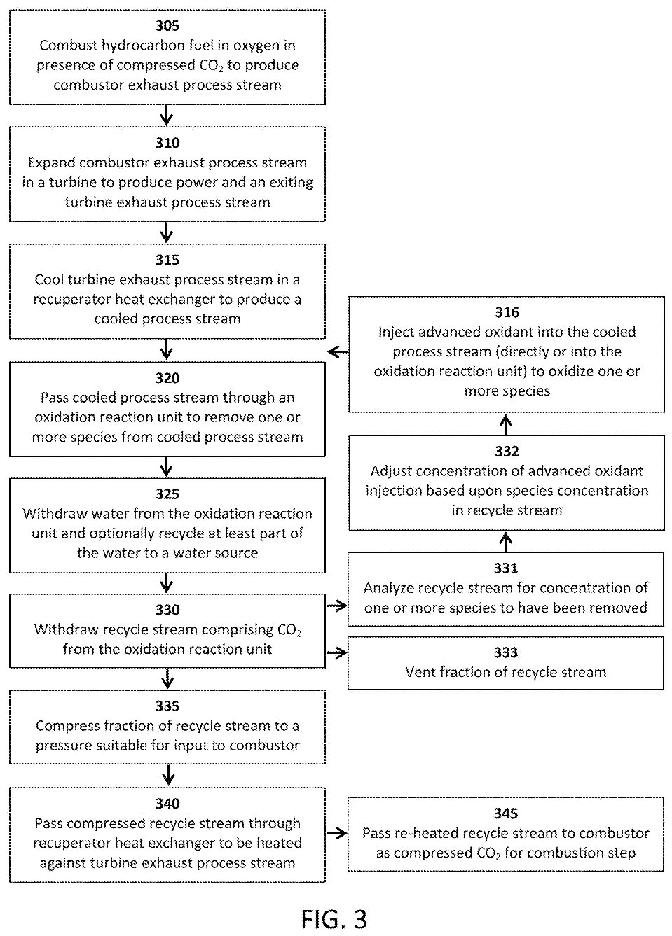

The present disclosure further can provide for a method for oxidation of one or more species in a process stream. Such method can be defined in relation to FIG. 3 as further described below. In action 305, a hydrocarbon fuel is combusted in oxygen in the presence of compressed CO₂ to produce a combustor exhaust process stream. In action 310, the combustor exhaust process stream is expanded in a turbine to produce power and an exiting turbine exhaust process stream. In action 315, the turbine exhaust process stream is cooled in a recuperator heat exchanger to produce a cooled process stream. It is understood, that actions 305, 310, and 315 can be carried out in embodiments wherein the oxidation method is carried out in combination with a power production method. Thus, actions 305, 310, and 315 may be replaced by further actions whereby a cooled process stream is provided. In action 320, the cooled process stream is passed through an oxidation reaction unit to remove one or more species from the cooled process stream. In action 325, water is withdrawn from the oxidation reaction unit and, optionally, at least part of the water is recycled to a water source. In action 330, a recycle stream comprising CO₂ is withdrawn from the oxidation reaction unit. The recycle stream may be considered a product stream in that the CO₂ may be a product. In action 335, a fraction of the recycle stream is compressed to a pressure suitable for input to the combustor. In action 340, the compressed recycle stream is passed through the recuperator heat exchanger to be heated against the turbine exhaust process stream. In action 345, the re-heated recycle stream is passed to the combustor as the compressed CO₂ for use in the combustion action 305. It again is understood that actions 335, 340, and 345 can be carried out in embodiments wherein the oxidation method is carried out in combination with a power production method. Thus, actions 335, 340, and 345 may be absent or replace with other actions. In action 316 (which is executed before or concurrently with action 320), advanced oxidant is injected into the cooled process stream (directly or into the oxidation reaction unit) to oxidize the one or more species. In action 331, the recycle stream is analyzed to evaluate the concentration of the one or more species that were to have been removed. In action 332, the concentration of the advanced oxidant being injected is adjusted based upon the species concentration as measured in the recycle stream. In action 333, at least a fraction of the recycle stream is vented (which can include removing for sequestration or other end uses).

Many modifications and other embodiments of the invention will come to mind to one skilled in the art to which this invention pertains having the benefit of the teachings presented in the foregoing descriptions and associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1-20. (canceled)

21. A system for power production, the system comprising:
a combustor configured for receiving a hydrocarbon fuel, an oxidant, and a stream comprising compressed CO2 and configured for output of a combustion process stream;
a turbine configured to expand the combustion process stream to produce power and output a turbine exhaust process stream including one or more species, the one or more species including at least NOx and SOx;
a process stream line configured for passage of the turbine exhaust process stream including the one or more species;
a recuperative heat exchanger configured to receive and cool the turbine exhaust process stream;
an oxidation reaction unit arranged downstream from the recuperative heat exchanger and configured to receive a vapor phase of the turbine exhaust process stream and further cool the vapor phase to a desired temperature;
a water input line configured for passage of a recirculating stream of water to the oxidation reaction unit;
a sensor configured to indicate a concentration of NOx and SOx in the oxidation reaction unit and determine when a concentration limit for one or both of NOx and SOx is met;
an advanced oxidant line controlled by the sensor and configured for continuous injection of an advanced oxidant to one or more of the process stream line, the water input line, and the oxidation reaction unit when the concentration limit for one or both of NOx and SOx is met and at a rate to reduce the concentration of the one or both of NOx and SOx to below their concentration limit; and
a compressor arranged downstream of the oxidation reaction unit and configured to receive a recycle stream;
wherein SOx and NOx at least partially convert to acids in the presence of the advanced oxidant and the recirculating stream of water.

22. The system of claim 21, wherein the one or more species further includes one or more of an acid gas, CO, H2, COS, H₂S, and a hydrocarbon.

23. The system of claim 21, wherein the recuperative heat exchanger is configured to cool the process stream below a dew point of water.

24. The system of claim 21, further comprising a filter arranged upstream of the recuperative heat exchanger and configured to filter the process stream as the vapor phase, where a portion of the one or more species are captured.

25. The system of claim 24, wherein a liquid phase of the cooled process stream is removed before input of the vapor phase of the cooled process stream at the oxidation reaction unit.

26. The system of claim 21, further comprising a cooling tower interposed in the water input line and configured to cool the recirculating stream of water before input to the oxidation reaction unit.

27. The system of claim 21, further comprising a water output line is configured for removal of the water from the oxidation reaction unit; and
a line configured for removal of the acids from the oxidation reaction unit

28. The system of claim 21, wherein the recycle stream comprises substantially pure CO2 withdrawn from the oxidation reaction unit.

29. The system of claim 21, wherein the oxidation reaction unit is a packed scrubbing column or a water separator.

30. The system of claim 21, wherein the oxidation reaction unit is configured to receive the recirculating stream of water and the turbine exhaust process stream in an opposing configuration.

31. The system of claim 21, wherein the advanced oxidant comprises a material other than O2 that is suitable to provide a reactive oxygen species in situ.

32. The system of claim 31, wherein the advanced oxidant comprises a material that is suitable for in situ formation of a hydroxyl radical or a perhydroxyl radical.

33. The system of claim 31, wherein the advanced oxidant comprises a material with a reduction potential that is greater than 0.96 volts vs. Normal Hydrogen Electrode (NHE).

34. The system of claim 21, wherein the advanced oxidant is selected from the group consisting of peroxides, superoxides, ozone, halo-oxides, and combinations thereof.

35. The system of claim 34, wherein the advanced oxidant is a halo-oxide compound having the formula XzOy, wherein: X is Cl, Br, or I, and:
if X is Cl, then z is 1 and y is 1, 2, 3, or 4;
if X is Br, then z is 1 and y is 1, 2, 3, or 4; and
if X is I, then z is 1 and y is 3.

36. The system of claim 21, further comprising a controller in a working arrangement with the sensor and configured to control passage of the advanced oxidant through the advanced oxidant line.
